(19) United States
(12) Patent Application Publication
(10) Pub. No.: US 2005/0043034 A1
(43) Pub. Date: Feb. 24, 2005

(54) Method of providing or receiving cell load information using at least dual periodicity

(76) Inventors: Hisham S. Abdel-Ghaffar, Tinton Falls, NJ (US); Jens Mueckenheim, Nuremberg (DE)

Correspondence Address: HARNESS, DICKEY & PIERCE, P.L.C., P.O. Box 8910, Reston, VA, 20195, US

(21) Appl. No.: 10/645,856

(22) Filed: Aug. 22, 2003

(51) Int. Cl. H04Q 7/20

(52) U.S. Cl. 455/453

(57) ABSTRACT

A method of providing and/or receiving cell load information in a wireless communication system where the cell load information is provided and/or received at a first periodicity when in a period of low cell loading and received at a second periodicity, higher than the first periodicity when in a period of high cell loading. A method of providing and/or receiving cell load information in a wireless communication system where the cell load information is provided and/or received based on periodic events and threshold-driven events.

### BACKGROUND OF THE INVENTION

FIG. 1 illustrates the conventional third generation partnership project (3GPP) network 10, which may include a core network (CN) 12 and UMTS Terrestrial Radio Access Network (UTRAN) 14. The UTRAN 14 may further include a number of Radio Network Subsystems (RNSs) 16, 16′, etc., where each RNS 16, 16′ further includes a Radio Network Controller (RNC) 18, 18′, etc., interconnected with a plurality of Node Bs 20, 22, 20′, 22′, etc., through lub interfaces. Each Node B may include one or more cells 24, 24′, etc., which comprise the functionality of a cell site, which communicate with user equipment UE. As a 3G system, 3GPP has been designed to support a large number of services and data rates, including voice and data with wide range of bearer rates between 32 kbps-2.048 Mbps.

The operation and performance of UTRAN may be dependent on the frequency and precision of both uplink (UL) and downlink (DL) cell load measurements. The latter are measured by the cells and sent to the RNC 18, 18′ over the lub in the form of common measurement reports via a Node B Application Part (NBAP) protocol, which provides different vehicles for initiating the reports via “event triggering” or “periodic reporting”. Common measurement reports are then used by the RNC 18, 18′ to implement various Call Admission Control (CAC) tasks.

If the rate of cell load measurements (or common measurement reports) is too low, the CAC performance will be impacted. However, if the rate is too high, the common measurement reports coming from so many cells will represent a to great a signalling burden on the RNC 18, 18′ (and possibly the Node Bs 20, 22, 20′, 22′) processors and the associated lub transport network. Hence, the design of a proper common measurement algorithm is a useful task.

Generally, two scenarios are possible. The two scenarios are:
1. If the cell supports a small set of bearer services and/or small capacity, where the cell load doesn't exhibit large dynamic variations, it is generally sufficient to report at a low rate using a single type of event triggering (e.g., “Event-F”) that captures significant load thresholds.
2. If the cell supports a large number of bearer services and/or large capacity, dynamic bearer control (DBC) may be used which may require load measurements. High frequency periodic reporting is a valid option to sustain performance, but may cause an aggregate signalling load on the RNC 18, 18′ and transport network as mentioned above.

The process of call admission control (CAC) for a cell in UTRAN may involve three main tasks:
1. Overload Control—which ensures that the downlink transmitted power (TSSI) or uplink RSSI load is, upon admission, smaller than the CAC_thr for new normal calls, or smaller than ConC_thr (Congestion Control threshold) for new emergency calls.
2. Channelization Code Allocation—which ensures that a downlink code within the total allocated orthogonal variable spreading factor (OVSF) code space is available for the requested service.
3. Channel Element (CE) Assignment—which ensures that a Dedicated Channel (DCH) within the total allocated Node B radio resources is available for the requested service.

In addition to the above, the dynamic bearer control (DBC) algorithm may act as a link between the three tasks when new service requests or current service assignments need to be compromised to match the system limitations imposed by the three tasks.

Of the three tasks, the overload control (task 1) may be used as the front-end main control. Common cell load measurements in 3GPP include several types of overload control including:
RSSI (received signal strength indicator, or received total wideband power, RTWP): for example, measured over 100 ms interval in dBm within [−112 dBm, 50 dBm] with resolution 0.1 dBm.
   Since overload control may require the noise rise over noise floor not RSSI, the noise floor may be measured and tracked using the lowest obtained RSSI samples in a systematic manner. A noise floor estimation need not impose a requirement on the continuity of RSSI measurements at a minimum frequency (indicated by the period “measurement_period_long”). Method of estimating the noise floor itself are conventional and therefore a noise estimate is assumed available.
TSSI (transmitted signal strength indicator, or transmitted carrier power, TCP): measured over 100 ms in absolute percentage within [0%, 100%] with resolution 1%.
PRACH (Physical Random Access Channel) preamble acknowledgements: measured over 20 ms interval.

As the 3GPP technology implementation evolves, equipment vendors may transition from a system release that supports a small set of bearer services and/or small capacity per cell (scenario 1) to a subsequent releases that support a larger set of bearer services and/or larger capacity per cell (scenario 2).

In scenario 1, overload control is usually not a problem even though the DBC, CAC and ConC thresholds may occasionally be exceeded. Therefore, a simplified “Event F” triggered load measurement scheme, which slowly measures the RSSI load periodically (e.g., every measurement_period_long=15 min) to track the noise floor and then captures the onset of DBC, CAC and ConC thresholds for both RSSI and TSSI, may suffice for the limited set of data rates.

In scenario 2, a larger set of services is employed, for which the DBC algorithm may not be able to manage the CAC process by computing “load consumption values” to ensure that the load level does not exceed the admission threshold of interest after the new admission. Hence, the overload control task may be subjected to a full dynamic-range exhaustive testing that requires adoption of an appropriate common measurement scheme with sufficient precision and frequency, which are not sustained by Event-Triggered measurement that only captures the DBC, CAC and ConC thresholds.

Therefore periodic reporting (e.g., every measurement_period=1-10 sec with a default value of 5 sec) may be necessary. However, this raises a concern of the impact of frequent measurements on the RNC and/or Node B CPU and transport network loads.

Conventional measurement method for UMTS using the NBAP protocol utilize at least three absolute load thresholds: DBC, CAC and ConC, with default values 50%, 75% and 90%, respectively (for both UL and DL). Using these formulas,
UL_{—}Load=1−(1/noise_{—}rise)=1−(RSSI/noise_{—}floor)
and, DL_Load=TSSI.

The corresponding RSSI and TSSI thresholds may be evaluated as:
thr_{—}RSSI1=20−10·log10(100−thr_{—}DBC_{—}UL)+noise_{—}floor
thr_{—}RSSI2=20−10·log10(100−thr_{—}CAC_{—}UL)+noise_{—}floor
thr_{—}RSSI3=20−10·log10(100−thr_{—}ConC_{—}UL)+noise_{—}floor
thr_{—}TSSI1=thr_{—}DBC_{—}DL
thr_{—}TSSI2=thr_{—}CAC_{—}DL
thr_{—}TSSI3=thr_{—}ConC_{—}DL.

Two conventional measurement methods for UMTS using the NBAP protocol are illustrated in FIGS. 2 and 3. These measurement techniques may use a triple (or double) Event-F triggering method with a hysteresis value (default 5 sec). Event-F can trigger periodic reporting on the falling edge (below threshold 1) then abort periodic reporting on the rising edge (above threshold 2) if the report periodicity IE is set. Hence, the periodicity may be set for the lowest threshold (DBC) event for RSSI only to track the noise floor. FIG. 2 illustrates a conventional UMTS Event-F triggered common measurement for RSSI. As shown in FIG. 2, a periodic event, measurement_period_long, is used until a threshold, either Event 1, 2, or 3, is exceeded or gone below. FIG. 3 illustrates a periodic common measurement for RSSI (and also for TSSI and PRACH acknowledgements). As shown in FIG. 3, measurements are taken every measurement_period_short, regardless of whether a threshold is exceeded or not.
For RSSI:
   Event 1:
   Threshold1=Threshold2=thr_RSSI1
   measurement hysteresis time=[0-30] sec, default 5 sec
   report periodicity IE with reporting period=measurement_period_long=[1-60]min, default 15 min.
   Event 2:
   Threshold1=Threshold2=thr_RSSI2
   measurement hysteresis time=[0-30] sec, default 5 sec
   no report periodicity IE.
   Event 3:
   Threshold1=Threshold2=thr_RSSI3
   measurement hysteresis time=[0-30] sec, default 5 sec
   no report periodicity IE.
For TSSI:
   Event 4:
   Threshold1=Threshold2=thr_TSSI1
   measurement hysteresis time=[0-30] sec, default 5 sec
   no report periodicity IE.
   Event 5:
   Threshold1=Threshold2=thr_TSSI2
   measurement hysteresis time=[0-30] sec, default 5 sec
   no report periodicity IE.
   Event 6:
   Threshold1=Threshold2=thr_TSSI3
   measurement hysteresis time=[0-30] sec, default 5 sec
   no report periodicity IE.
For PRACH Acknowledgements:
   Event 7:
   Threshold1=Threshold2=thr_PRACH
   measurement hysteresis time=[0-30] sec, default 5 sec
   no report periodicity IE.
   Event 5:
   Threshold1=Threshold2=0.8*thr_PRACH
   measurement hysteresis time=[0-30] sec, default 5 sec
   no report periodicity IE.

### SUMMARY OF THE INVENTION

Exemplary embodiments of the present invention are directed to a method for taking measurements based on a dual periodic technique.

Exemplary embodiments of the present invention are directed to a method for taking measurements compatible with a dynamic bearer control algorithm. Exemplary embodiments of the present invention are directed to a method for taking measurements for RSSI with both Events E and F and for TSSI and PRACH preamble acknowledgements with Event E only.

Exemplary embodiments of the present invention are directed to a method for taking measurements for use in an UMTS system. Exemplary embodiments of the present invention may also be used in other wireless technology based on the principle of dual periodicity for cell load measurement.

Exemplary embodiments of the present invention improve measurement precision and/or frequency and/or reducing processing and transport network loads.

Exemplary embodiments of the present invention may be used for either dedicated or shared channels.

In an exemplary embodiment, the present invention is directed to a method of providing and/or receiving cell load information in a wireless communication system comprising providing and/or receiving the cell load information at a first periodicity when in a period of low cell loading and receiving the cell load information at a second periodicity, higher than the first periodicity when in a period of high cell loading.

In another exemplary embodiment, the present invention is directed to method of providing and/or receiving cell load information in a wireless communication system comprising providing and/or receiving the cell load information based on periodic events and threshold-driven events.

### BRIEF DESCRIPTION OF THE DRAWINGS

Exemplary embodiments of the present invention will become more fully understood from the detailed description given below and the accompanying drawings, which are given for purposes of illustration only, and thus do not limit the invention.

FIG. 1 illustrates the conventional third generation partnership project (3GPP) network.

FIG. 2 illustrates a conventional UMTS Event-F common measurement for RSSI.

FIG. 3 illustrates a conventional periodic common measurement for RSSI, TSSI and PRACH acknowledgements.

FIG. 4 illustrates a dual periodic technique in an exemplary embodiment of the invention.

FIG. 5 illustrates a dynamic bearer control (DBC) in an exemplary embodiment of the invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION OF THE EXEMPLARY EMBODIMENTS

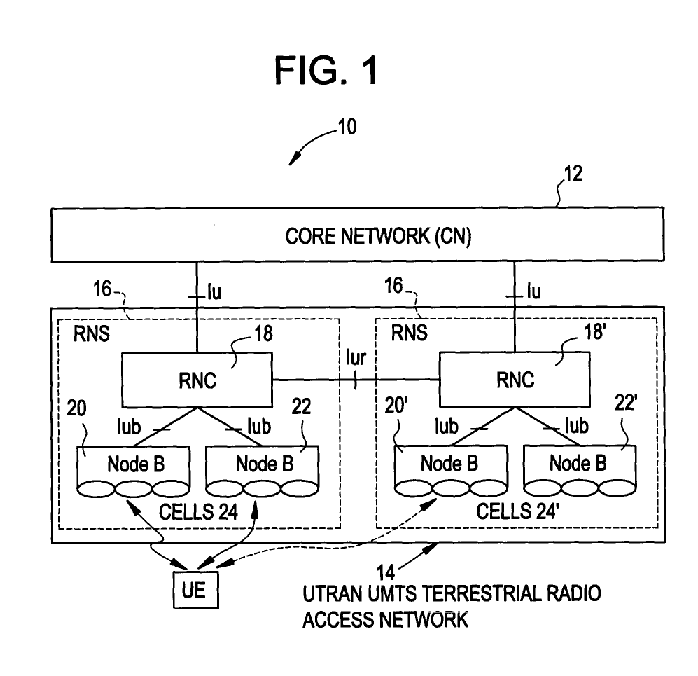

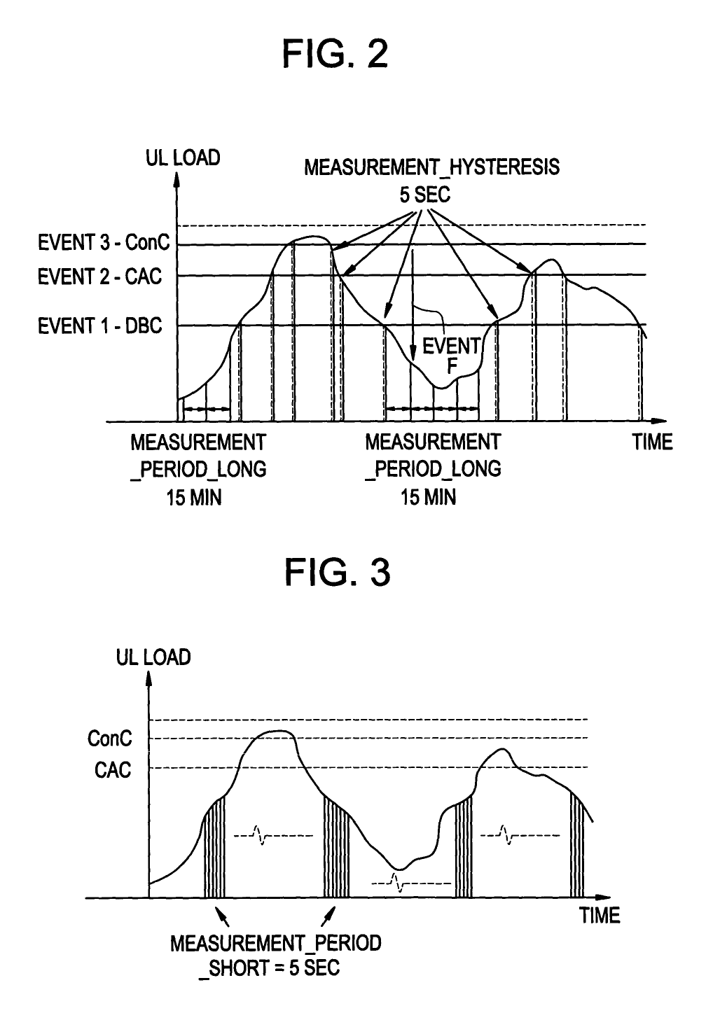

In an exemplary embodiment, the present invention is directed to a method for providing or receiving cell load information in a wireless communication based on a dual (or higher) periodic scheme. In an exemplary embodiment, the present invention is directed to a method which is operable in a 3G network, such as the 3GPP network illustrated in FIG. 1.

In an exemplary embodiment, the present invention is directed to a method of receiving cell load information in a wireless communication system, where the cell load information is received at a first periodicity when in a period of low cell loading and received at a second periodicity, higher than the first periodicity when in a period of high cell loading.

In an exemplary embodiment, the present invention is directed to a method of providing the cell load information based on periodic events and/or threshold-driven events.

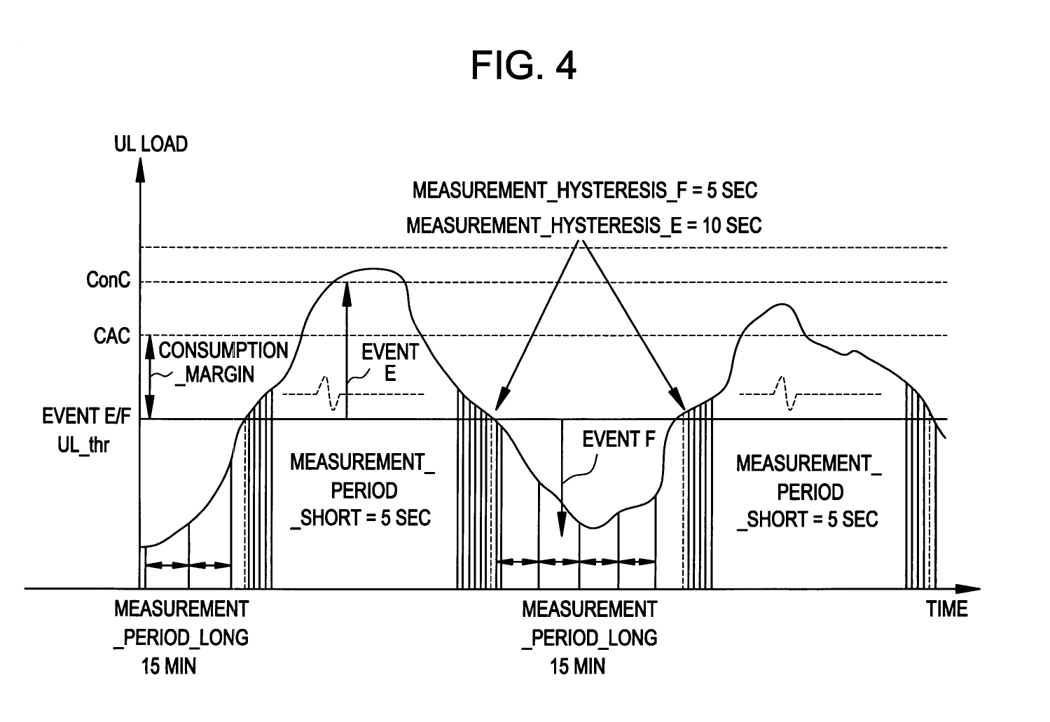

FIG. 4 illustrates an exemplary embodiment of the present invention, where a first threshold, Measurement_period_long, and a second threshold, Measurement_period_short are both utilized.

In an exemplary embodiment, the dual-periodic measurement method is designed to comply with the DBC algorithm for scenario 2. The DBC algorithm works by estimating consumption values and cell edge/cell centre consumption values for each service rate, such that, upon admission, the total load is still within the admission threshold of interest.

In an exemplary embodiment of the invention, a DBC algorithm may be used and may be applied to a UMTS. For the purpose of this example, the DBC algorithm description below should be interpreted within the following notation:
The threshold thr_DBC may be equal to (or to be replaced by) thr_CAC.

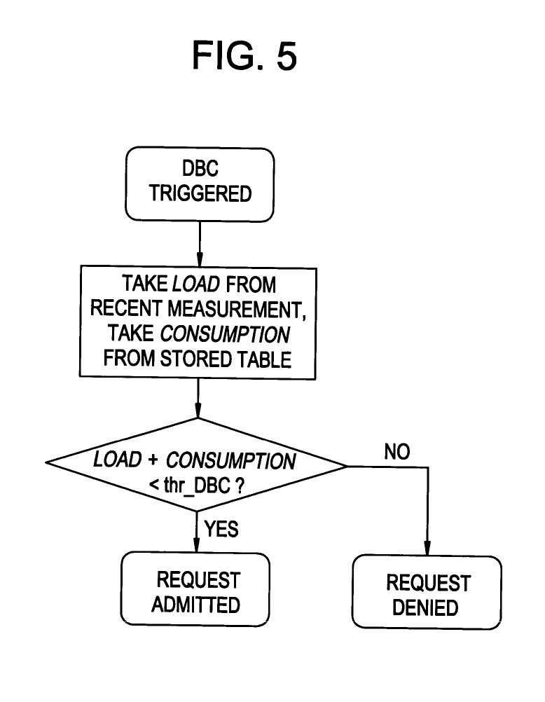

As depicted in FIG. 5, in an exemplary embodiment:
1. DBC may be triggered by the following events:
   Move from URA_PCH/CELL_FACH to CELL_DCH.
   Establishment of new RB within CELL_DCH.
   Indicator of demand for increased data rate in CELL_DCH.
2. The load may be taken from a most recent measurement result in UL & DL and from each cell the UE is in soft handoff (or shall go into from CELL_FACH or URA_PCH). The resource consumption may be taken for the highest allowed data rate from a table, that is stored (by any known technique) in the RNC according to the following rules:
   In the UL, take the resource consumption according to the requested QoS (data rate) of the service.
   In the DL, take the resource consumption according to the requested QoS (data rate) of the service and the environment of the UE.
3. Compare the sum of load & consumption against the DBC threshold:
   If load+consumption<thr_DBC (UL & DL, each cell), then admit the request with the requested QoS.
   If load+consumption>=thr_DBC (UL or DL, one cell), then do not admit the requested QoS.
   Furthermore check also the availability of channelization codes in the cells. This check may be performed for uplink and downlink and in each cell, separately. The DBC may pass when the conditions have been fulfilled for each cell and direction. A separate check on available DL code transmit power may be performed.
4. The request may be admitted and assigned TFS/TFCS for the user service/service combination. The assigned data rate may be determined as follows:
   assigned rate=min(max rate DBC, max rate user),
   max rate DBC: data rate, which can be supported within the current load situation, coming from DBC check.
   max rate user: data rate, which may be allocated in maximum to a specific user, coming from initial RB setup request. This may be used to differentiate between different classes.
5. The request for the current QoS cannot be admitted. When negotiation is allowed, take the next lower QoS (data rate) and continue with step 2. When the request was not granted for minimum data rate, then finally deny the request. It is noted that a voice service may not be for negotiation.

For voice service, step 2 & 3 may be reduced to take the load only and check it against a threshold.

TABLE 1

| | consumption_DL | | |
|---|---|---|---|
| | DL_environment_{—} | DL_environment_{—} | |
| Service | status = Cell centre | status = Cell edge | consumption_UL |
| 32k | 0.9% | 3.8% | 1.9% |
| 64k | 1.6% | 6.8% | 3.4% |
| 128k | 2.9% | 12.9% | N/A |
| 256k | 5.7% | 24.5% | N/A |
| 384k | 8.3% | 36.5% | N/A |

An example of resource consumption is shown in Table 1. In UL, the resource consumption may depend on the requested QoS of the service. In DL, the environment of the UE may have to be accounted for. In Table 1, the environment has been divided into two main scenarios: Cell center and Cell edge. As shown, at the cell edge, the service consumes more resources than at the cell center. It is noted that DBC may only estimate the resource consumption of the new requested service, while the load is a measured value.

The allocation of the users into one of these categories may follow a conservative rule allocating worst case consumption using the following heuristic:
From Table 1, it is clear that a wrong decision to a higher consumption leads in most of the scenarios only to a lower rate allocation than realistically possible. It can be expected that this will mostly not result in erroneously blocking of the service.
The conservative consumption setting efficiently prevent or reduces the possibility of the worst case, that the new user will affect the existing users, when the data rate was allocated too high having a relaxed strategy.
In the regular case, because the consumption is usually estimated above the real one, the conservative strategy may allow to give some free space for new user request afterward the admitted one.

In summary, the following technique for estimating the UE environment may be used for DBC:
1. Perform the algorithm every time a UE measurement report for CPiCH EcI0 arrives. The following may trigger the algorithm:
   When the UE moves from URA_PCH to CELL_DCH, the EcI0 may be reported on RACH in the URA_update message. When the UE moves from CELL_FACH to CELL_DCH, the EcI0 may be reported on RACH in case of UL originated transition (i.e. buffer overflow reported).
   In case of other reasons for transition from CELL_FACH to CELL_DCH, such as DL buffer overflow, there may be no EcI0 report available from the UE. Then, no direct estimate can be given.
   Every time a soft handover link addition, link deletion or link replacement message arrives from the UE, the EcI0 may be included in the message.
2. Calculate an effective EcI0′ depending on the soft handover status (for example, as follows):
   If the UE is in soft HO or wants to go into soft HO, take the sum over all reported EcI0 (linear) within the active set having: EcI0′=(Σ_{jεactive set}(EcI0ⱼ′)).
   If the UE is not in soft HO and does not want to go into soft HO, take EcI0′=EcI0 from that link the UE has established the (single) radio link or wants to establish the radio link.
3. Compare the EcI0′ (in dB) against a threshold EcI0ₜₕᵣ as follows:
   If EcI0′>EcI0ₜₕᵣ, then indicate the UEs environment as “Cell center”.
   If EcI0′<=EcI0ₜₕᵣ, then indicate the UEs environment as “Cell edge”.
4. For each user, the environment status may be accessible from DBC and ConC.

In an exemplary embodiment of the present invention, the method assumes that proper consumption values are available and the following exemplary parameters may be defined:
Max_consumption_UL=Max {all UL consumption values over all supported services}
Max_consumption_DL=Max {all DL consumption values over all supported services and DL_environments}. (1)

For example, if 384 kbps is the maximum supported DL rate, then Max_consumption_DL=consumption_DL{384, cell edge} and is about 36.5% (as shown in Table 1). Similarly, if 64 kbps is the maximum supported UL rate, Max_consumption_UL=consumption_UL{64}=3.4%.

In an exemplary embodiment, the method of the present invention operates by assuming at least one load threshold “thr_UL” for the UL and/or at least one load threshold “thr_DL” for the DL and monitoring the cell load above and below the threshold(s). The cell may, therefore, exist in one of two loading states:
A “normally-loaded” state: The cell load is below the thr_UL (or thr_DL), and hence measurement reports can be reported periodically at an interval “measurement_period_long”.
A “critically-loaded” state: The cell load is equal to or above the thr_UL (or thr_DL), such that a single incoming call can drive the cell load above the CAC threshold. This suggests that, in this state, the cell load may be measured more frequently, and hence measurement reports can be reported periodically at an interval “measurement_period_short”.

Having defined the critically-loaded state as above, the algorithm threshold may be computed based on the consumption margin needed to support the worst cases call as follows:
thr_{—}UL=thr_{—}CAC_{—}UL−Consumption_{—}margin_{—}UL
thr_{—}DL=thr_{—}CAC_{—}DL−Consumption_{—}margin_{—}DL (2)
where,
Consumption_{—}margin_{—}UL=Max_{—}consumption_{—}UL+3%
Consumption_{—}margin_{—}DL=Max_{—}consumption_{—}DL+3%. (3)

Equation 1 may assume that “thr_CAC” is the maximum threshold not to be exceeded for admission of normal calls. Equations (1), (2) and (3) may describe the load thresholds for an exemplary embodiment of the method of the present invention. The exemplary value of 3% is added in Equation (3) as a safety margin.

In general, the consumption margins are about 40% for the DL and 6.5% for the UL. Hence, with thr_CAC=75%, general threshold ratio estimates are given by:
thr_{—}UL/thr_{—}CAC_{—}UL≈68.5/75=0.91
thr_{—}DL/thr_{—}CAC_{—}DL≈35/75=0.47 (4)

Equation (4) assists in understanding the common measurement load for the exemplary method(s) of the present invention. By comparing to scenario 1 with Event-F triggering and thr_DBC=50% (or 0.67 of thr_CAC), Equation (4) indicates that the UL measurement can be relaxed much more (about 91%) while the DL should be watched more closely (about 47%).

Once the thr_UL or thr_DL are exceeded, the CAC and ConC algorithms in the RNC may resume in a normal manner and there is no need to define triggering events based on thr_CAC and thr_ConC that are higher than the proposed algorithm threshold, since measurement reports already arrive frequently.

The TSSI and RSSI thresholds may be computed as:
thr_{—}RSSI=20−10·log10(100−thr_{—}UL)+noise_{—}floor
thr_TSSI=thr_DL (5)

Exemplary embodiments of the method of the present invention may also be applied to PRACH measurement for scenario 2 with “measurement_period_short_PRACH”=measurement_period_short so that RACH and RSSI measurements can be coordinated. The PRACH threshold may be set as 0.8* thr_PRACH (as an example) or by defining a new thr_PRACH by multiplying the old thr_PRACH by 0.8.

As discussed above, an exemplary embodiment of the method of the present invention is depicted in FIG. 4. The recommended values (measurement_period long=15 min, and for measurement_period_short=5 sec) are merely numerical examples.

In an exemplary embodiment, a NBAP implementation of the present method is based on both “Event E” and “Event F” for RSSI as shown in FIG. 4. Event E is the complementary analog to Event F, as it triggers periodic measurement on the rising edge (above threshold 1) then abort periodic reporting on the falling edge (below threshold 2) if the report periodicity IE is defined Therefore, “Event E” with measurement_period_short and thr_RSSI computed as above may be used, and for “Event F” with measurement_period_long and the same threshold thr_RSSI. For TSSI, “Event E” only with measurement_period_short and thr_TSSI computed as above may be used.

With regard to measurement hysteresis, since both events E and F have the same thresholds, their measurement hystereses, measurement_hysteresis_E” and “measurement_hysteresis_F” may be distinguished to avoid collisions of measurement reports. FIG. 4 shows this phenomenon. The following equation is an example for relating the two hysteresis values whenever Events E and F are combined:
Measurement_{—}hysteresis_{—}E=Measurement_{—}hysteresis_{—}F+Measurement_{—}period_{—}short (6)

Exemplary report characteristics for both RSSI and TSSI for the proposed algorithm are set forth in Table 2. Both Event E and F are combined into one “common measurement initiation request” as shown in Table 2.

TABLE 2

| IE/Group Name | Value/Range | Recommended Default | NBAP IE Type and Range |
|---|---|---|---|
| CHOICE Report Characteristics | | | |
| >Event E | | | |
| >>Measurement Threshold 1 | thr_RSSI | As Computed | INTEGER(0 . . . 621) |
| >>Measurement Threshold 2 | thr_RSSI | Same as Threshold 1. | INTEGER(0 . . . 621) |
| >>Measurement Hysteresis | Measurement_hysteresis_E | Measurement_hysteresis_F + | ENUMERATED |
| Time | [0-30] sec | Measurement_period_short = | (10 ms . . . 1 min, . . . ) |
| | | 10 sec. | step 10 ms, . . . |
| >>Report Periodicity | Measurement_period_{—} | 5 sec. | ENUMERATED |
| | short | | (10 ms . . . 1 min, . . . ) step 10 ms, |
| | [0.1-10] sec | | (1 min . . . 1 hr, . . . ) step 1 min, . . . |
| >Event F | | | |
| >>Measurement Threshold 1 | thr_RSSI | Same as Event E. | INTEGER(0 . . . 621) |
| >>Measurement Threshold 2 | thr_RSSI | Same as Event E. | INTEGER(0 . . . 621) |
| >>Measurement Hysteresis | Measurement_hysteresis_F | 5 sec | ENUMERATED |
| Time | [0-30] sec | | (10 ms . . . 1 min, . . . ) |
| | | | step 10 ms, . . . |
| >>Report Periodicity | Measurement_period_{—} | 15 min | ENUMERATED |
| | short | | (10 ms . . . 1 min, . . . ) step 10 ms, |
| | [1-60] min | | (1 min . . . 1 hr, . . . ) step 1 min, . . . |

Event E only is included in the common measurement initiation request for TSSI as shown in Table 3 below.

TABLE 3

| IE/Group Name | Value/Range | Recommended Default | NBAP IE Type and Range |
|---|---|---|---|
| CHOICE Report Characteristics | | | |
| >+UZ,1/5 Event E | | | |
| >>Measurement Threshold 1 | thr_TSSI | As Computed | INTEGER(0 . . . 100) |
| >>Measurement Threshold 2 | thr_TSSI | Same as Threshold 1. | INTEGER(0 . . . 100) |
| >>Measurement Hysteresis | Measurement_hysteresis_E | Measurement_period_short = | ENUMERATED |
| Time | [0-30] sec | 5 sec. | (10 ms . . . 1 min, . . . ) step 10 ms, . . . |
| >>Report Periodicity | Measurement_period_{—} | 5 sec. | ENUMERATED |
| | short | | (10 ms . . . 1 min, . . . ) step 10 ms, |
| | [0.1-10] sec | | (1 min . . . 1 hr, . . . ) step 1 min, . . . |

Event E only is included in the common measurement initiation request for PRACH Acknowledgments as shown in Table 4 below.

TABLE 4

| IE/Group Name | Value/Range | Recommended Default | NBAP IE Type and Range |
|---|---|---|---|
| CHOICE Report Characteristics | | | |
| >Event E | | | |
| >>Measurement Threshold 1 | thr_PRACH | As Computed | INTEGER(0 . . . 240, . . . ) |
| >>Measurement Threshold 2 | thr_PRACH | Same as Threshold 1. | INTEGER(0 . . . 240, . . . ) |
| >>Measurement Hysteresis | Measurement_hysteresis_E | Measurement_period_short = | ENUMERATED |
| Time | [0-30] sec | 5 sec. | (10 ms . . . 1 min, . . . ) step 10 ms, . . . |
| >>Report Periodicity | Measurement_period_{—} | 5 sec. | ENUMERATED (10 ms . . . 1 min, . . . ) |
| | short | | step 10 ms, |
| | [0.1-10] sec | | (1 min . . . 1 hr, . . . ) step 1 min, . . . |

Exemplary embodiments of the present invention for reducing the amount of measurement signalling can be also applied for downlink shared channel, such as the UMTS (DSCH). For DSCH, the task of load control may be different from DCH. Normally, on DSCH, a scheduler is used, which autonomously schedules data flows for different users in the way that a pre-assigned maximum amount of downlink resources in terms of Tx power is not exceeded. To achieve this target, the scheduler may use internal measurements, such as QoS, data rate, buffer occupancy for its scheduling decisions. The details of various scheduling method are known to one of ordinary skill in the art and hence will not be described here.

As described above, the TSSI measurement is used for the purpose of downlink overload control. The scheduler on the DSCH does not implicitly need the TSSI measurement. However, for the purpose of detecting overload for ConC or handling of a mix between DSCH and DCH by means of CAC the measurement of TSSI may be valuable. The TSSI need only be reported, when it reaches the limit, which has been assigned to DSCH.

To handle DSCH, in an exemplary embodiment of the present invention, the DCH load reporting may be modified as follows:
a portion, DSCH_portion, of the total transmit power may be allocated to the DSCH. For example, DSCH_portion=75% may be a useful allocation for DSCH, when mostly packet services shall be supported.
a TSSI measurement need only to be reported, when it is in the region around DSCH_portion.
therefore, the same exemplary methods to reduce measurement signalling can be applied as for DCH. The setting of the threshold for the TSSI measurement on DSCH may be as follows:
   thr_TSSI=DSCH_portion (6a)

Other parameters, such as measurement period and hysteresis time may be the same as described above for DCH.

System Information Blocks (SIB's) represent the main information elements sent by the RNC to the cell, to be broadcast to all UE's for control of various tasks. For overload control, a type of SIB, SIB type 7, is relevant, which may require the contributions of RSSI and PRACH Acknowledgment measurements.

As described above, exemplary embodiments of the present invention may also be applied to PRACH measurement for scenario 2 using Event E only with “measurement_period_short_PRACH”=measurement_period_short so that PRACH and RSSI measurements can be coordinated. Even if PRACH and RSSI measurements are coordinated, this doesn't automatically guarantee that SIB_{—}7 updates are coordinated with them in all cases.

The RNC may maintain for each cell an expiration timer for SIB 7. This timer may be (re) initialized on the following events:
(re) initialization of the cell.
After SIB 7 has been updated by the RNC.

Therefore, SIB 7 may be updated in two cases:
Deliberately whenever the RNC receives and processes the RSSI and PRACH updates every measurement_period_short or measurement_period_long.
By force when the SIB 7 timer expires where there is no new update data available to be reported for SIB 7. This expiry condition may be identifed for abnormal scenarios.

The expiration time of SIB 7 timer may be set to a maximum, such as MAX{320 ms, Expiration_Timer_Factor*SIB7_REP}. Hence, to avoid false updating in normal situations, the following exemplary parameters may be used:
Expiration_{—}Timer_{—}Factor_{—}Short*SIB7_{—}REP>measurement_{—}period_{—}short=5 sec
Expiration_{—}Timer_{—}Factor_{—}Long*SIB7_{—}REP>measurement_{—}period_{—}long=900 sec (7)

It is known that SIB7_REP should be constant so that the UE expects SIB7 at steady intervals, but equation (7) assumes that Expiration_Timer_Factor can have two values based on the load state.

“SIB7_REP” is an interval that resumes values (40, 80, 160, 320, 640, 1280, 2560, 5120, 10240, 20480) milliseconds, with a practical minimum of 640 ms for BCH operation. Also, the “Expiration_Timer_Factor” is an integer that resumes values (2, 4, 8, 16, 32, 64, 128, 256) with default=2. With SIB7_REP=0.64 sec, false SIB 7 update cannot be avoided in the low load state. Using 900/256=3.5, the minimum SIB7_REP to avoid false updates would be 5.12 sec. Using measurement_period_short and Expiration_Timer_Factor=2 (default), the minimum SIB7_REP to avoid false updates=2.56 sec. Thus, it may be beneficial to increase the default Expiration_Timer_Factor to reduce false SIB 7 updates. To conclude, it is easy to guarantee that false SIB 7 updates are avoided when the cell is in the critically loaded state, while it may not be possible to avoid such false updates at low or normal loads.

It may also be useful to calculate the peak rate, \hat{R}, and the mean rate, \overline{R}, of the number of RSSI and TSSI reports per cell and per RNC for exempalry embodiments of the present method. Assuming N_{Cells}_{_{—}}ₚₑᵣ_{_{—}}_{RNC} as the total number of cells per RNC (e.g., 48*3=144), there are two cases to analyze. Below is the analysis only for RSSI and TSSI, but the same analysis can be extended and applied to the PRACH preamble measurement (similar to TSSI) and hence, to SIB_{—}7 updates.

Assuming all cells can reach the critically-loaded state simultaneously and independently of any capacity constraints,

$$\begin{matrix}{\hat{R}}_{RSSI , Cell} = \frac{1}{measurement\_period \_short} \\ {\hat{R}}_{TSSI , Cell} = \frac{1}{measurement\_period \_short} & ( 8 ) \\ {\hat{R}}_{RSSI , RNC} = \frac{{N}_{Cells\_per \_RNC}}{measurement\_period \_short} \\ {\hat{R}}_{TSSI , RNC} = \frac{{N}_{Cells\_per \_RNC}}{measurement\_period \_short} & ( 9 )\end{matrix}$$

As a result, the peak load of exemplary embodiments of the present invention may be the same or substantially the same as the load of conventional periodic measurement methods.

The peak load of exemplary embodiments of the present invention is obtained based on the probabilities (as percentages of time) that the UL or DL carried cell load stays in the normal state or critically loaded state. If

$${p}_{low , UL} = Pr [ UL\_Load < thr\_UL ] \approx \frac{thr\_UL}{thr\_CAC \_UL} \\ {p}_{low , DL} = Pr [ DL\_Load < thr\_DL ] \approx \frac{thr\_DL}{thr\_CAC \_DL} \qquad ( 10 )$$

Equation (10) approximates the probabilities by assuming a sort of linear relationship of cell load versus time, which is not necessarily accurate. For example, during busy hours, cells tend to have higher loads more often than lower loads. As more accurate probability expressions are available, they can be substituted for p_{low, UL} and p_{low, DL} below. However, the expressions of (10) and the numerical values of (4) provide significant insight, hence,

$$\begin{matrix}\begin{matrix}{\overline{R}}_{RSSI , Cell} = [ \begin{matrix}\frac{( 1 - {p}_{low , UL} )}{measurement\_period \_short} + \\ \frac{{p}_{low , UL}}{measurement\_period \_long}\end{matrix} ] \\ \approx \frac{( 1 - {p}_{low , UL} )}{measurement\_period \_short}\end{matrix} \\ {\overline{R}}_{TSSI , Cell} = \frac{( 1 - {p}_{low , DL} )}{measurement\_period \_short} & ( 11 ) \\ \begin{matrix}{\overline{R}}_{RSSI , RNC} = {N}_{Cells\_per \_RNC} \times [ \begin{matrix}\frac{( 1 - {p}_{low , UL} )}{measurement\_period \_short} + \\ \frac{{p}_{low , UL}}{measurement\_period \_long}\end{matrix} ] \\ = \frac{{N}_{Cells\_per \_RNC} ( 1 - {p}_{low , UL} )}{measurement\_period \_short}\end{matrix} \\ {\overline{R}}_{TSSI , RNC} = \frac{{N}_{Cells\_per \_RNC} ( 1 - {p}_{low , DL} )}{measurement\_period \_short} & ( 12 )\end{matrix}$$

Equations (11) and (12) indicate that the cell load in some cases may not even last in the low/normal state for as long as 15 min (default of measurement_period_long), hence such state is aborted with a report rendering the effective value of measurement_period_long significantly smaller than 15 min. However, such effective value would still be much larger than measurement_period_short and the approximation in Equations (11) and (12) is therefore useful.

Equations (4), (11) and (12) indicate the mean load of the dual-periodic algorithm is smaller than that of the periodic measurement method by about 91% for the UL RSSI and 47% for the DL TSSI, which is a major load reduction on the RNC.

The peak load per cell is the same as in Equation (8), and the peak load per RNC can also be obtained by conventional techniques. Assuming that Nₜₕᵣ_{_{—}}_{UL}_{_{—}}_{Cells}_{_{—}}ₚₑᵣ_{_{—}}_{RNC} and Nₜₕᵣ_{_{—}}_{DL}_{_{—}}_{Cells}_{_{—}}ₚₑᵣ_{_{—}}_{RNC} are the maximum number of cells that can operate at thr_UL and thr_DL, as computed by Equation (2), such that the RNC capacity is not exceeded. The Consumption_margin of Equation (3) may be evaluated based on the maximum service but applied to the whole cell load regardless of its service mix. Hence, Nₜₕᵣ_{_{—}}_{UL}_{_{—}}_{Cells}_{_{—}}ₚₑᵣ_{_{—}}_{RNC} and Nₜₕᵣ_{_{—}}_{DL}_{_{—}}_{Cells}_{_{—}}ₚₑᵣ_{_{—}}_{RNC} can be computed for either a single or a mix of services based on the RNC capacity using the same threshold of Equation (2). Hence,

$$\begin{matrix}{{R}^{⋒}}_{RSSI , RNC} = [ \begin{matrix}\frac{{N}_{thr\_UL \_Cells \_per \_RNC}}{measurement\_period \_short} + \\ \frac{( {N}_{Cells\_per \_RNC} - {N}_{thr\_UL \_Cells \_per \_RNC} )}{measurement\_period \_long}\end{matrix} ] \\ \approx \frac{{N}_{thr\_UL \_Cells \_per \_RNC}}{measurement\_period \_short}\end{matrix} \\ {{R}^{⋒}}_{TSSI , RNC} = \frac{{N}_{thr\_DL \_Cells \_per \_RNC}}{measurement\_period \_short} \qquad ( 13 )$$

Generally, it cannot be determined whether Nₜₕᵣ_{_{—}}_{UL}_{_{—}}_{Cells}_{_{—}}ₚₑᵣ_{_{—}}_{RNC} and Nₜₕᵣ_{_{—}}_{DL}_{_{—}}_{Cells}_{_{—}}ₚₑᵣ_{_{—}}_{RNC} are smaller than or just equal to N_{Cells}_{_{—}}ₚₑᵣ_{_{—}}_{RNC}, especially for the DL with the smaller threshold (47%). But for the UL, there is a load reduction with the larger threshold (91%). Hence, the constrained RNC peak load of Equation (13) is generally smaller than the unconstrained RNC peak of Equation (9), especially for the UL RSSI.

When the RNC capacity constraint exists, it may be difficult to compute the mean value of common measurement load and simplifying assumptions may be made. One problem is the definition of the state probabilities per cell as percentages of time. Under capacity constraint, such probabilities are difficult to define based on the cell carried load, but rather may be based on the offered load. Therefore,
q_{low,UL}=Pr[Offered UL_{—}Load<thr_{—}UL]
q_{low,DL}=Pr[Offered DL_{—}Load<thr_{—}DL] (14)

Equation (14) may be linearly approximated by the result of Equation (10) to a first degree or computed using a conventional secondary analysis. Since the carried load is smaller than the offered load, every cell may report every measurement_period_long with probability q_{low, UL} (or q_{low, DL}). With probability (1−q_{low, UL}) [or (1−q_{low, DL})], only a certain number of cells, k≦Nₜₕᵣ_{_{—}}_{UL}_{_{—}}_{Cells}_{_{—}}ₚₑᵣ_{_{—}}_{RNC} (or Nₜₕᵣ_{_{—}}_{DL}_{_{—}}_{Cells}_{_{—}}ₚₑᵣ_{_{—}}_{RNC}) can report every measurement_period_short and the rest of the cells should report every measurement_period_long. Another problem may be with the probability distribution of “k”, since the cell loads are not precisely independent. However, assuming independence, a binomial distribution may be used where:

$${P}^{UL} ( k ) = ( \begin{matrix}{N}_{Cells\_per \_RNC} \\ k\end{matrix} ) {( 1 - {q}_{low , UL} )}^{k} {q}_{low , UL}^{( {N}_{Cells\_per \_RNC} - k )} \\ {P}^{DL} ( k ) = ( \begin{matrix}{N}_{Cells\_per \_RNC} \\ k\end{matrix} ) {( 1 - {q}_{low , DL} )}^{k} {q}_{low , DL}^{( {N}_{Cells\_per \_RNC} - k )} \qquad ( 15 )$$

Using Equation (15), the mean common measurement load may be obtained as follows:

$$\begin{matrix}{\overline{R}}_{RSSI , RNC} = {\sum }_{k = 0}^{{N}_{thr\_UL \_Cells \_per \_RNC}} {P}^{UL} ( k ) \\ [ \begin{matrix}\frac{k}{measurement\_period \_short} + \\ \frac{( {N}_{Cells\_per \_RNC} - k )}{measurement\_period \_long}\end{matrix} ] + \\ Pr [ k > {N}_{thr\_UL \_Cells \_per \_RNC} ] \cdot \\ [ \begin{matrix}\frac{{N}_{thr\_UL \_Cells \_per \_RNC}}{measurement\_period \_short} + \\ \frac{( {N}_{Cells\_per \_RNC} - {N}_{thr\_UL \_Cells \_per \_RNC} )}{measurement\_period \_short}\end{matrix} ] \\ \approx [ {\sum }_{k = 0}^{{N}_{thr\_UL \_Cells \_per \_RNC}} {kP}^{UL} ( k ) + \\ {N}_{thr\_UL \_Cells \_per \_RNC} PR [ k > {N}_{thr\_UL \_Cells \_per \_RNC} ] ] \cdot \\ \frac{1}{measurement\_period \_short} \\ {\overline{R}}_{TSSI , RNC} = [ {\sum }_{k = 0}^{{N}_{thr\_DL \_Cells \_per \_RNC}} {kP}^{DL} ( k ) + \\ {N}_{thr\_DL \_Cells \_per \_RNC} Pr [ k > {N}_{thr\_DL \_Cells \_Per \_RNC} ] ] \cdot \\ \frac{1}{measurement\_period \_short}\end{matrix} \qquad ( 16 )$$

The mean load of Equation (16) is smaller than the peak load of Equation (13). Further, if Nₜₕᵣ_{_{—}}_{UL}_{_{—}}_{Cells}_{_{—}}ₚₑᵣ_{_{—}}_{RNC}>(1−q_{low, UL})*N_{Cells}_{_{—}}ₚₑᵣ_{_{—}}_{RNC} (the latter is the binomial probability mean), the ratio of the mean to the peak load is close to 0.5. Hence, there may be an additional inherent reduction in the mean common measurement load if RNC capacity constraints are imposed. Once Equation (16) is evaluated, the mean common measurement load per cell may be given by:
\overline{R}_{RSSI,Cell}=\overline{R}_{RSSI,RNC}/N_{Cells}_{_{—}}ₚₑᵣ_{_{—}}_{RNC}
\overline{R}_{TSSI,Cell}=\overline{R}_{TSSI,RNC}/N_{Cells}_{_{—}}ₚₑᵣ_{_{—}}_{RNC} (17)

The RNC capacity constraint is also reflected in the mean cell load of Equation (17).

The exemplary embodiments of the present invention described above, offer several advantages, including:
Dual periodicity being applied for cell load common measurements.
Combining Events E and F from the NBAP implementation perspective.
Incorporation of the DBC algorithm consumption values into the load measurement threshold.
The applicability of the proposed measurement algorithm for TSSI to the downlink DSCH channel admission control (as well as DCH).
The adaptability of the proposed algorithm to the supported cell service mix by adjusting the consumption margins.
Applying all the above in the UMTS load measurement context.

The exemplary embodiments of the present invention described above, may also offer other benefits, such as the reduction of the Node B and RNC common measurement signalling loads.

Although exemplary embodiments of the present invention are generally described in the context of a UMTS system, the teachings of the present invention may be applied to other systems, wired or wireless, voice, data, or a combination thereof, as would be known to one of ordinary skill in the art.

For example, although the terminology utilized in conjunction with the exemplary embodiments described above include “RNC” and “Node B”, such an arrangement could also be utilized in North American systems, including base station controllers and base stations, as would be known to one of ordinary skill in the art.

As described above, the cell load information may be provided or received on a dedicated channel or a shared channel, as would be known to one of ordinary skill in the art.

Still further, although the exemplary embodiment of FIG. 4 illustrates a change in the period upon exceeding a first threshold and maintaining that periodicity for subsequent thresholds, it would be apparent to one of ordinary skill in the art, that a secondary threshold, such as the CAC threshold, could initiate a different periodicity, for example, an even shorter periodicity, either on the way up or on the way down. Further, even yet another periodicity could be implemented upon exceeding a third threshold, such as the ConC threshold, illustrated in FIG. 4, as would be known to one of ordinary skill in the art.

Still further, one of ordinary skill in the art would recognize that a different periodicity for the same threshold could be utilized depending on whether the threshold is exceeded or gone below. Such an event may be termed a “virtual event”.

The invention may be embodied in other forms without departing from its spirit and essential characteristics. The described embodiments are to be considered only non-limiting examples of the invention. The scope of the invention is to be measured by the appended claims. All changes which come within the meaning and equivalency of the claims are to be embraced within their scope.

1. A method of receiving cell load information in a wireless communication system comprising:
receiving the cell load information at a first periodicity if in a period of low cell loading and receiving the cell load information at a second periodicity, higher than the first periodicity if in a period of high cell loading.

2. The method of claim 1, wherein the cell load information is received on one of a dedicated channel and a share channel.

3. The method of claim 1, wherein the wireless communication system is a universal mobile telephone service (UMTS) system.

4. A method of providing cell load information in a wireless communication system comprising:
providing the cell load information at a first periodicity if in a period of low cell loading and providing the cell load information at a second periodicity, higher than the first periodicity if in a period of high cell loading.

5. The method of claim 4, wherein the cell load information is provided on one of a dedicated channel and a share channel.

6. The method of claim 4, wherein the wireless communication system is a universal mobile telephone service (UMTS) system.

7. A method of receiving cell load information in a wireless communication system comprising:
receiving the cell load information based on periodic events and threshold-driven events.

8. The method of claim 7, wherein for the periodic events, the cell load information is received at a first periodicity if in a period of low cell loading and at a second periodicity, higher than the first periodicity if in a period of high cell loading.

9. The method of claim 7, wherein the threshold-driven events are determined based on one or more thresholds.

10. The method of claim 9, wherein the one or more threshold is a virtual threshold, with differing resulting periodicities depending on whether the one or more threshold is exceeded or gone below.

11. The method of claim 7, wherein the cell load information is received on one of a dedicated channel and a share channel.

12. The method of claim 9, wherein the one or more thresholds are adaptive depending on at least one of cell loading and cell service mix.

13. The method of claim 9, wherein the one or more thresholds are based on one or more consumption values.

14. The method of claim 13, wherein the one or more consumption values are generated by a dynamic bearer control algorithm.

15. The method of claim 7, wherein the wireless communication system is a universal mobile telephone service (UMTS) system.

16. A method of providing cell load information in a wireless communication system comprising:
providing the cell load information based on periodic events and threshold-driven events.

17. The method of claim 16, wherein for the periodic events, the cell load information is provided at a first periodicity when in a period of low cell loading and at a second periodicity, higher than the first periodicity when in a period of high cell loading.

18. The method of claim 16, wherein the threshold-driven events are determined based on one or more thresholds.

19. The method of claim 16, wherein the one or more threshold is a virtual threshold, with differing resulting periodicities depending on whether the one or more threshold is exceeded or gone below.

20. The method of claim 16, wherein the wireless communication system is a universal mobile telephone service (UMTS) system.
